(19) United States
(12) Patent Application Publication
(10) Pub. No.: US 2004/0055481 A1
(43) Pub. Date: Mar. 25, 2004

(54) Sheet punching or stamping and embossing machine

(76) Inventors: Gerhard Klassen, Monchengladbach (DE); Hermann Namowitz, Bruggen (DE)

Correspondence Address: LERNER AND GREENBERG, P.A., POST OFFICE BOX 2480, HOLLYWOOD, FL, 33022-2480, US

(21) Appl. No.: 10/670,661

(22) Filed: Sep. 25, 2003

(30) Foreign Application Priority Data
Sep. 25, 2002 (DE) 102 44 585.0

(51) Int. Cl. B31F 1/07; B44B 5/00; B41F 19/02

(52) U.S. Cl. 101/3.1

(57) ABSTRACT

A sheet punching and embossing machine includes a stationary table provided with a counter plate, a movable table provided with a punching knife, and a stroke drive for reciprocatingly moving the movable table vertically relative to the counter plate. The reciprocating stroke drive has at least one eccentric shaft mounted in a machine frame and pressure rollers eccentrically mounted on the eccentric shaft. The reciprocating stroke drive further includes a non-uniformly acting mechanism for imparting a non-uniform movement to the movable table.

### BACKGROUND OF THE INVENTION

Field of the Invention

The invention relates to a sheet punching or stamping and embossing machine having a stationary table provided with a counter plate and a table provided with a punching knife and being reciprocatingly movable perpendicularly to the counter plate by a stroke drive. The stroke drive has at least one eccentric shaft mounted in the machine frame and pressure rollers eccentrically mounted on the eccentric shaft.

A drive of the foregoing general type for a sheet punching and embossing machine is disclosed in German Patent DE 30 44 083 C3, corresponding to U.S. Pat. Nos. 4,903,560 and 4,470,593. The machine described therein has a fixed lower table, and a reciprocable upper table for punching sheets of paper, paperboard and the like. The reciprocatory movement of the upper table is realized via rollers which are disposed on two eccentric shafts disposed above the upper table. The upper table is spring-biased against the rollers on the eccentric shaft. The upper table is moved perpendicularly towards the lower table by a rotary movement of the eccentric shafts. An at least approximately sinusoidal stroke movement of the upper table is produced by the eccentric drive over the course of time.

In the sheet punching and embossing machine, the sheets are gripped at the leading edge thereof by gripper bar configurations fastened to revolving chains and then intermittently pulled through the punching and embossing device and further stations. During the reciprocating movement of the upper table, the punched sheet must be moved out of the punching table and a new sheet must be inserted. In this regard, the sinusoidal curve of the stroke movement over the course of time opens a constantly remaining large time window which depends, of course, upon the rotational speed of the eccentric shaft. That time window is limited by the minimum stroke of the upper table required by the gripper bars for the passage underneath the upper table. The movement and resting times of the gripper bars are thus determined. However, the cycle times of the machine can be varied via the rotational speed of the eccentric shafts. In this regard, however, physical limits, such as the acceleration of the sheets, fix the maximum number of machine cycles and, therefore, the operating speed of the sheet punching and embossing machine. The time for accelerating and retarding the gripper bars can therefore no longer be shortened in order to increase the operating speed.

A further drive of the foregoing general type is described in U.S. Pat. No. 4,767,393. The punching and embossing machine described therein has a driven upper and lower table. In that regard, the drive is formed by disks disposed eccentrically on a shaft, which act directly on the upper and lower tables. A uniform movement of the upper and lower tables relative to one another is achieved via the eccentric disks by a rotary movement of the shafts.

### SUMMARY OF THE INVENTION

It is accordingly an object of the invention to provide a sheet punching and embossing machine, which overcomes the hereinafore-mentioned disadvantages of the heretofore-known devices of this general type and which has a punching and embossing station with a drive that permits an increase in an operating speed of the machine in a simple structural manner.

With the foregoing and other objects in view, there is provided, in accordance with the invention, a sheet punching and embossing machine comprising a stationary table provided with a counter plate, a movable table provided with a punching knife, and a stroke drive for reciprocatingly moving the movable table vertically relative to the counter plate. The reciprocating stroke drive has at least one eccentric shaft mounted in a machine frame and pressure rollers eccentrically mounted on the eccentric shaft. The reciprocating stroke drive further includes a non-uniformly acting mechanism for imparting a non-uniform movement to the movable table.

In accordance with another feature of the invention, the movable table bears with spring force against the pressure rollers of the reciprocating stroke drive.

In accordance with a further feature of the invention, the movable table is disposed above the stationary table.

In accordance with an added feature of the invention, the sheet punching and embossing machine further includes non-circular gears via which the drive for the eccentric shafts is provided.

In accordance with a concomitant feature of the invention, the sheet punching and embossing machine further includes a cam mechanism via which the drive for the eccentric shafts is provided.

Thus, in accordance with the invention, the drive for the eccentric shafts is provided by a mechanism acting non-uniformly, for imparting a non-uniform movement to the moving table. The non-uniform drive for the eccentric shafts provides the possibility for influencing the course over time of the acceleration and deceleration of the reciprocating movement of the movable table as desired and, thereby, increasing the operating speed of the machine.

For this purpose, a non-uniformly acting mechanism is provided as a drive for the eccentric shafts, at minimal expenditure with respect to costs, and with an extremely low construction outlay.

Other features which are considered as characteristic for the invention are set forth in the appended claims.

Although the invention is illustrated and described herein as embodied in a sheet punching or stamping and embossing machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of a basic structure of a sheet punching and embossing machine;

FIG. 2 is an enlarged, fragmentary view of FIG. 1 showing a sheet punching and embossing station of the sheet punching and embossing machine in greater detail, with eccentric shafts being driven by non-circular gears;

FIG. 2A is a view similar to that of FIG. 2, but with the eccentric shafts being alternatively driven by a cam drive; and

FIG. 3 is a plot diagram graphically illustrating a reciprocating movement of the upper table as a function of the rotary movement of the eccentric shafts, which is shown plotted in degrees of arc.

### DESCRIPTION OF THE PREFERRED EMBODIMENTS

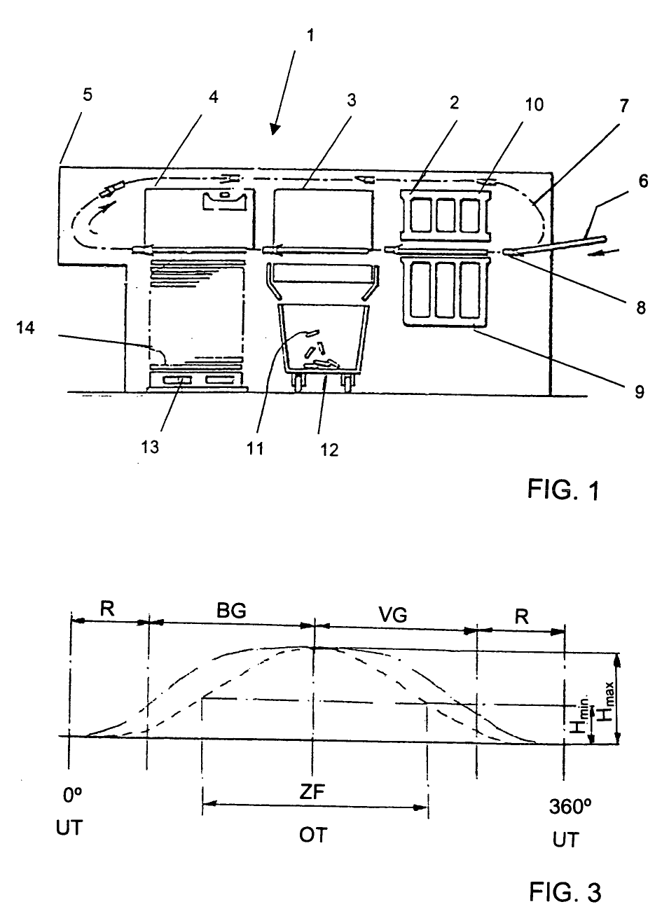

Referring now to the figures of the drawings in detail and first, particularly, to FIG. 1 thereof, there is seen a basic structure of a sheet punching and embossing machine 1 for punching, waste stripping and depositing sheets of paper, paperboard and the like. The punching and embossing machine 1 includes various stations, namely a punching device 2, a stripping device 3 and a depositing device 4, which are carried and enclosed by a common machine housing 5.

Sheets 6 are gripped at a leading edge thereof by gripper bars 8 fastened to revolving chains 7 and are pulled intermittently through the various stations 2, 3 and 4 of the punching and embossing machine 1.

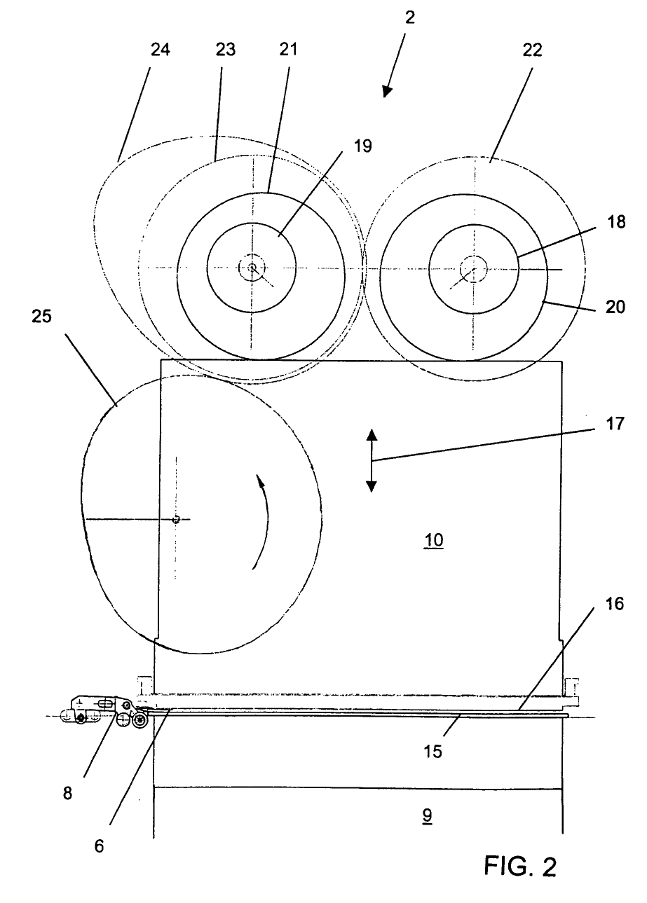

The station or punching device 2 is a punching and embossing station which has a lower table 9 and an upper table 10. The lower table 9 is fixedly mounted in the machine frame and provided, as shown in FIG. 2, with a counter plate 15 opposing a punching knife 16 carried by the upper table 10. The upper table 10 is reciprocatingly mounted and drivable by a drive apparatus described in greater detail below.

The gripper bar 8 transports the sheet 6 from the punching and embossing station 2 into the next following station 3 which is a stripping station to be equipped with stripping tools. In the stripping station 3, non-required pieces of waste 11 from the punched-out sheet 6 are downwardly expelled with the aid of the stripping tools. As a result, these pieces of waste 11 fall into a container-like trolley 12 pushed-in under the stripping station 3.

The sheet 6 passes from the stripping station 3 into the station 4 which is a deposit station wherein the sheet 6 is either only simply deposited or, more advantageously, separation of the individual blanks or copies takes place simultaneously. The deposit station 4 can also contain a pallet 13 whereon the individual sheets are stacked in the form of a pile 14, so that after a specific pile height has been reached, the pallets 13 with the stacked or piled sheets 14 can be moved away out of the region of the punching and embossing machine 1.

As may be apparent, the chains 7 carry a plurality of gripper bars 8, for example eight bars in the illustrated embodiment of FIG. 1. Therefore, several sheets 6 can be processed simultaneously in the various stations 2, 3 and 4. A preferred embodiment of the punching device 2 of the punching and embossing machine 1 of the invention is illustrated in greater detail in FIG. 2. The punching device 2 includes the stationary lower table 9 provided with the counter plate 15 and the upwardly and downwardly reciprocating upper table 10 provided with the punching knife 16. In the punching station 2, the sheet 6 is held between the counter plate 15 and the punching knife 16 by a gripper bar 8. In order to position the sheet 6 in the punching station 2 by a carriage of the gripper bar 8, the upper table 10 is moved vertically in the direction of an arrow 17 towards the lower table 9. The upper table 10 is kept under tension in the direction of eccentric shafts 18 and 19 by spring force.

The eccentric shafts 18 and 19 have eccentric holders whereon rotatably mounted pressure rollers 20 and 21 are fixed. A drive for the eccentric shafts is provided via gears 22 and 23 connected firmly to the respective eccentric shafts 18 and 19. In order to produce a non-uniform drive of the eccentric shafts 18 and 19, a non-circular gear 24 is firmly connected to the eccentric shaft 19. The non-uniformly acting mechanism of the drive for the eccentric shafts 18 and 19 in the illustrated exemplary embodiment of FIG. 2 includes the two non-circular gears 24 and 25. A drive, for example an electric motor, can then be connected directly to the noncircular gear 25.

The drive for the eccentric shafts illustrated in FIG. 2 constitutes the preferred embodiment of the invention. However, it is likewise conceivable to connect a further mechanism or a direct drive, such as a belt mechanism or a linkage, to the non-uniform mechanism having the gears 24, 25. A non-uniform movement is transmitted from the uniform movement of the driven non-circular gear 25 to the eccentric shaft 19 with the aid of the non-circular gear 24. The non-uniform movement is transmitted via the gear 23 to the gear 22 and, therefore, to the eccentric shaft 18, so that the two eccentric shafts 18 and 19 move synchronously, and move the upper table 10 in parallel in the direction of the lower table 9. The rotary movement of the eccentric shafts 18 and 19 is synchronous but in opposite directions.

In another alternative embodiment of the invention illustrated in FIG. 2A, the non-uniformly acting mechanism is a cam mechanism having gears 24′, 25′ which drives the eccentric shafts 18 and 19 non-uniformly. The cam mechanism having the gears 24′, 25′ is mounted in the machine housing or frame 5 and can be driven directly via an electric motor M or indirectly, for example via a belt mechanism, a linkage or comparable drives.

The eccentric shafts 18 and 19 move the upper table 10 in the direction of the arrow 17 and counter to the spring force acting on the sheet 6 to be punched. After the punching has occurred, the upper table moves in the direction of the eccentric shafts 18 and 19 again, and a new sheet 6 can be moved between the upper table 10 and the lower table 9.

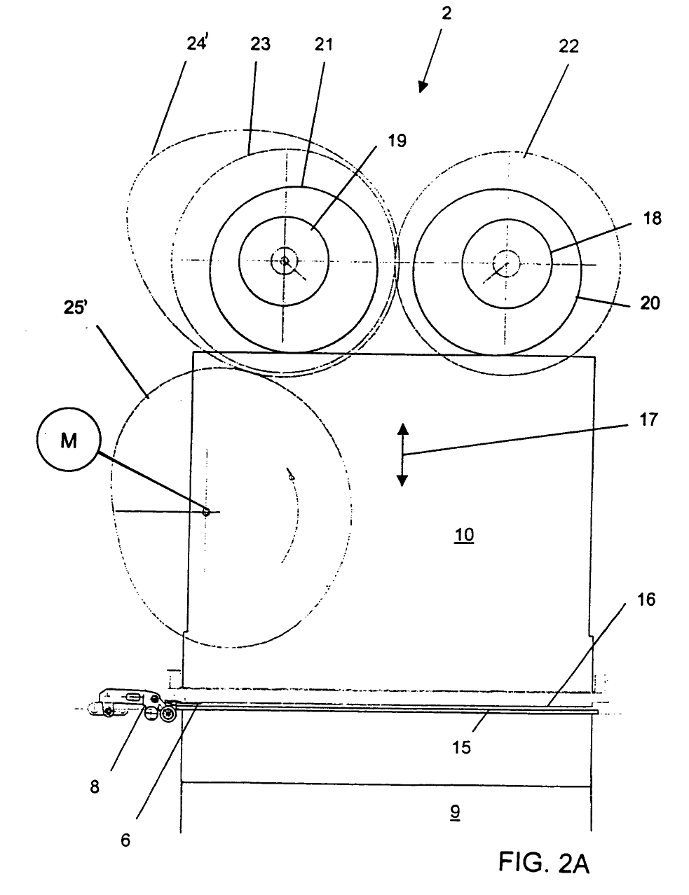

The course of the reciprocating movement of the upper table 10 over time is reproduced in FIG. 3, which shows a graph or plot diagram wherein the reciprocating movement of the upper table 10 is plotted in a broken line formed of dashes as a function of the angle of the eccentric shafts. The position 0° represents the lower dead point UT of the movement of the upper table 10, the position OT the upper dead point of the movement of the upper table 10, and the position 360° represents the next lower dead point UT of the upper table 10 as the next punching and/or embossing step.

The movements of the gripper bar 8 with the sheet 6 located thereon are represented above the line of movement of the reciprocating table, which is formed of dashes. The line formed of dashes illustrates a virtually sinusoidal course of a conventional eccentric shaft drive for the upper table 10. Starting at 0°, the gripper bar is at a standstill. It is located in the resting time period R. The gripper bar 8 is then accelerated as far as the time OT. The acceleration time of the gripper bar 8 is represented by BG. Approximately at the upper dead point, i.e., the turning point of the upper table 10, the gripper bar 8 is also decelerated over the time period VG, until it comes to a standstill. A further resting time period R follows.

In order to move the gripper bar 8, the upper table 10 must have a prescribed minimum stroke Hmin. From this minimum stroke Hmin, a time window ZF results, during which the gripper bar 8 has had to move the sheet 6 out between the upper table 10 and the lower table 9 and inserted it in again.

Beyond or outside of this time period ZF there may be only small acceleration and deceleration phases of the gripper bar 8. The acceleration phase of the upper table 10 from the lower dead point UT is virtually identical with the deceleration phase before the upper dead point OT. However, because the gripper bar 8 can be moved only after the height Hmin has been reached, and the acceleration and deceleration phases of the gripper carriage BG, VG cannot be shortened further for physical reasons, the time window ZF can be displaced, for example, by a steeper rise of the movement curve of the upper table 10. A displacement of the time window ZF to a start earlier in time can be carried out as a result of a steeper rise in the movement curve of the upper table 10. This results in shorter resting time periods R of the gripper bar 8, and thus shorter cycle times for punching the sheets 6. The dash-dot line is supposed to represent the steeper course of the acceleration of the upper table 10.

The cycle times for the acceleration BG and the deceleration VG of the gripper bar are physically bound at limits. Above a prescribed acceleration, the gripper bar 8 can no longer guide the sheet 6 reliably, so that the time window can be varied only slightly. The use of a non-uniform mechanism for driving the eccentric shafts 18 and 19, however, has the effect of greater acceleration of the upper table 10, so that the time window ZF can be enlarged or the resting time R can be shortened. In the preferred embodiment of the invention, the resting time R is reduced, so that the cycle time in the punching station 2 of the punching and embossing machine is shortened. In absolute values, a reduction in the resting time R from 90° to 70° can be indicated here, which corresponds to a reduction in the cycle time of about 5 to 6%.

The dash-dot line shows clearly that, as a result of the steeper rise in the acceleration curve of the upper table 10, the time window required for the movement of the gripper bar 8 can be displaced. The time window for moving the gripper bar 8 is prescribed by the physical limits. The time gain arising from the steeper rise of the movement curve of the upper table 10 can thus be used for reducing the cycle time of the punching or stamping station 2.

We claim:

1. A sheet punching and embossing machine, comprising:
a machine frame;
a stationary table having a counter plate;
a movable table having a punching knife; and
a stroke drive for reciprocatingly moving said movable table vertically relative to said counter plate, said reciprocating stroke drive having at least one eccentric shaft mounted in said machine frame, pressure rollers eccentrically mounted on said at least one eccentric shaft, and a non-uniformly acting mechanism for imparting a non-uniform movement to said movable table.

2. The sheet punching and embossing machine according to claim 1, wherein said movable table bears with spring force against said pressure rollers of said reciprocating stroke drive.

3. The sheet punching and embossing machine according to claim 1, wherein said movable table is disposed above said stationary table.

4. The sheet punching and embossing machine according to claim 1, further comprising non-circular gears providing said drive for said eccentric shafts.

5. The sheet punching and embossing machine according to claim 1, further comprising a cam mechanism providing said drive for said eccentric shafts.
